(19) United States
(12) Patent Application Publication
(10) Pub. No.: US 2011/0066571 A1
(43) Pub. Date: Mar. 17, 2011

(54) Method of Marketing Real Estate Investment Trust and/or Fund by the Internet

(76) Inventor: Mark A. Goodman, Glencoe, IL (US)

(21) Appl. No.: 12/879,889

(22) Filed: Sep. 10, 2010

Related U.S. Application Data
(60) Provisional application No. 61/241,688, filed on Sep. 11, 2009.

(51) Int. Cl. G06Q 40/00

(52) U.S. Cl. 705/36 R

(57) ABSTRACT

A method of marketing and managing a real estate investment trust or fund through the Internet and existing Internet brokerage entities enables lower cost investment trust units subjective to unique marketing techniques, lower brokerage charges, lower management charges and greater transparency. Other costs associated with the securing of investment funds are reduced and smaller, incremental investments will be made available thereby allowing a broad spectrum of inventors eligible to make such investments. Investment units may be as low as $3,000.

### CROSS REFERENCE TO RELATED APPLICATION

This is a utility application which claims priority to and incorporates by reference previously filed provisional application Ser. No. 61/241,688 filed Sep. 11, 2009 entitled “Method of Marketing Real Estate Investment Trust and/or Fund by the Internet”.

### BACKGROUND OF THE INVENTION

A basic premise is that real estate prices are driven by availability of credit. When availability declines, real estate prices drop. Cash investors will then have the opportunity to buy the properties in the market trough.

However, it may be difficult to raise capital for real estate investment. One method that seems to be raising money is the public non-listed REIT'S. The problem with this business model, however, is that the cost of raising capital is very high. Typically, money is raised through a broker-dealer network. The commissions when combined with other costs, results in only 82-85 cents will be available to invest. The cost of distribution is inefficient, so that it is not a good transaction for the investor.

Most of the sponsors for investment are driven by the fees rather than the investment. Institutional investors are often burdened with “legacy” deals that are underperforming. As a result, the traditional sources of equity capital for real estate are limited, especially since minimum participation may require investing high five or six figure amounts for a participating share.

### SUMMARY OF THE INVENTION

A proposed solution to this dilemma is to establish a public non-listed REIT structure or fund structure in which an individual investor could participate for as little as $3,000. Importantly, all fund raising and operations are conducted via the Internet.

Many economists consider the current recession to be the worst worldwide economic downturn since the Great Depression. Despite a modest downturn in 2001-2002, the past 19 years are aptly described as a period of significant economic growth that began in the early 1990's and culminated in an unsustainable bubble in 2008. During this time the world's economy grew by unprecedented rates fostered by the availability of extremely cheap credit. Although many sectors of the economy experienced unsustainable growth, residential and commercial real estate led the charge. Cracks began appearing as early as 2005, but the big crash in prices and values did not occur until 2008. From the early 1990s until 2008, total leverage-defined as debt as a percentage of asset value—increased from about 35% to 65%, while debt divided by net operating income (NOI) increased from about 3.5 to 7.5.

We are now experiencing a rapid deleveraging as debt levels approach those of the early 1990s. This is consistent with the idea that commercial real estate operates on a 16-19 year cycle.¹ We are now, as we were in the early 1990s, approaching the bottom of the cycle: while prices are low, credit is tight and thus no one is buying. This represents an opportunity for investors with cash. They can purchase properties at low prices now when no one else can afford them, improve and manage the properties over time, and then sell them in 7-12 years when property values approach their peak, buyers are plentiful, and credit is once again low cost and available. ¹ Substantial evidence supports the idea of a 16-19 year commercial real estate cycle. One author, Ray Wenzlich at Research Corporation in St Louis, Mo., analyzed data from 1870 through 1955. He found the data led to an average cycle time of 18⅓ years.

Points of Distinction

Unburdened by unprofitable or non-performing legacy assets.

Public, non-traded/listed REIT reduces correlations with stock market and frees management to focus on delivering value.

Extremely high degree of transparency combined with superior ability to execute transactions and manage portfolio.

Timed to take maximum advantage of the commercial real estate cycle.

Green, sustainable focus.

Low cost of raising capital puts more of investors' money to work.

Extremely low management fees align investors and management to share in the Fund's success.

According to the FDIC, banks now have an aggregate of $1.07 trillion in core commercial real estate loans on their books. This does not include $590 billion in construction loans, $205 billion in multifamily loans, or $63 billion in farm loans. To appreciate the size of this market it is useful to note that there were 54,079 outstanding CMBS² loans at the end of 2008, with a total value of $601.9 billion. This represents less than half of the commercial real estate loans on the books.

The investment community's repetitive failure to recognize the cyclical nature of the real estate industry creates the potential for above average returns,” where a fund with significant capital reserves can stand to make substantial returns for its investors.³ Given the tightening credit markets, numerous commercial loans are now being called. Investors will find the best bargains by buying when everyone else needs to sell and will receive their best price as a seller, when everyone else is buying. The best way to accomplish this is to have significant cash or equity to invest that is not dependent on debt. This allows one to invest in real estate, independent of capital market pressures or conditions. It permits an independence of actions that provides for a sound investment policy based on the best real estate strategies. ² Collateralized Mortgage Backed Securities³ Comer, K. “REITs: Completing the Cycle.” Bankers Trust Research (n.d.).

In the coming years, there will be a number of sources for a Fund's commercial real estate portfolio. These include banks, pension funds, commercialized mortgage backed securities (CMBS), and distressed sellers. Assets will be structured in any of the following ways: wholly owned, preferred equity, gap equity, or as a Joint Venture with pension funds or other institutions.

Public, non-traded REITs have several advantages over publicly traded REITs. They typically offer dividend yields of 6% to 6.5% (contrast with publicly traded REITs, which typically offer dividend yields of only 3.25% to 5.0%). The fact that non-traded REITs are illiquid is considered a positive by many people, since this means the Fund avoids the rampant volatility associated with a publicly traded entity, thereby reducing the correlation with the stock market. The fact that such a fund will have a limited lifetime is also a positive, since the fund's purpose is to purchase properties near the trough of the commercial real estate cycle and then sell them near the peak of the cycle.

The evolution of the fund can be described in terms of four overlapping stages: Raising Capital, Acquisitions, Management, and Dispositions. The bulk of the investment funds will be raised during the first 2 years. Under traditional capital raising methods, the cost of raising the capital can reach as high as 15% to 20% of each dollar raised. Novel fundraising strategies lower the cost of raising capital. Direct fundraising over the Internet and using insurance brokers as commissioned resellers. The goal is to cut the cost of raising capital down to 5% to 10% of each dollar raised. Moreover, if the full impact of the Internet can be fully realized, as the lowest-cost distribution channel, the cost of raising capital could be even less than 5%.

Most property acquisitions will be made within the first 2 years. The next 4-6 years will focus on portfolio management and development. Finally, the majority of dispositions will occur during the last 2-3 years. This timing is designed to match the boom/bust nature of the commercial real estate cycle: capital raising and acquisitions happen while credit is still tight and rents and property prices are low. The portfolio then builds net operating income as rents and rent rolls increase. Finally, the Fund unwinds as property values approach their peaks.

Investors fall into three groups: upper middle-income individuals, high net worth individuals, and corporations and other institutions (such as pension funds). These groups will respectively invest amounts in the ranges of $3,000-$25,000, $25,000-$250,000, and $250,000-$25 million. Investors will purchase shares that yield annual dividends based on operating profits, which are distributed to shareholders on a quarterly basis. In addition to their annual preferred dividend payment for that year, investors will also receive 80% of the proceeds from the disposition of properties when the Fund ends in 7-12 years.

The fund will be a buy-side, low-load, diversified commercial real estate fund that prudently incorporates leverage. The Fund will invest primarily in high quality, iconic buildings in pre-eminent urban markets driven by scarcity including Chicago, New York, Los Angeles, San Francisco, Washington D.C., and Boston. Investments will be diversified across commercial sectors, including retail, office, warehouse and multifamily properties. Properties must be unique in design and location, and the purchase price and operating expenses must be low enough that future operating cash flows and a final sale will lead to significant, stable profits. Leverage will be kept low throughout the portfolio, but flexibility will be built-in so that different sectors will have different leverage guidelines. For example, the Fund may set a ceiling of 60% for retail, 70% multi-family, 40% office and 0% for land.

Acquisitions will be opportunistic in the sense that as high quality properties become available due to the threat of foreclosure or a seller's immediate need for cash, they will be purchased by the Fund.

Another aspect of the fund investment focuses on creating and sustaining long-term asset value, as opposed to a “quick flip” mentality. Green and sustainable building and management practices will lead to higher value and greater demand over time.

Operations

The total number of full-time personnel is expected to remain at or below 25 people throughout the lifetime of the Fund. This includes all major organization functions: administration, investor relations, information technology, legal, finance, and acquisitions/asset management/development. Non-core functions, such as information technology development and support, as well as some legal, marketing, and customer service functions, will be partly or completely outsourced to trusted third parties.

A formal Board of Directors, consisting of internationally known investors and CEOs, will oversee the Fund. Investment decisions will be made by an investment committee, the CEO, CFO, several EVPs⁴ and in-house legal counsel. Investment committee decisions will be aided by extensive data mining and analysis by third party research experts: an internationally known economist will provide macroeconomic forecasts and analyses of housing and business trends to predict which sectors will experience the most growth; a real estate research firm will provide regional analyses of occupancy, capacity, rental rates, etc.; and another firm will provide detailed demographic analyses at the city and regional levels. ⁴ Executive Vice Presidents

Operations will be funded through a combination of Fund management fees and a small percentage of net operating income from the property portfolio. Fees will be far lower than industry averages. In particular, the Fund management fee will be structured as a sliding scale percentage of capital invested, whereas the management fee will be a fixed percentage of net operating income. The fund will become more and more efficient as the size of the Fund grows.

Market Opportunity—Introduction

Economic cycles are an entrenched part of the capitalist system. As a part of the overall economy, the commercial real estate market is no different. Kenneth Fisher has studied the history of the real estate cycle and estimates that it resets approximately every 18⅓ years.⁵ The real estate cycle is now at or near its trough. This offers a tremendous opportunity for investors to purchase real estate assets now and then profit over time as prices increase and the credit markets loosen. ⁵ Fisher, Ken. The Wall Street Waltz. p. 135

The global economic downturn has produced a tightened lending environment, where available capital is scarce. The real estate market is now, as it was in the early 1990s, approaching the bottom of the cycle: prices are low, credit is tight and no one is buying. “The investment community's repetitive failure to recognize the cyclical nature of the real estate industry creates the potential for above average returns in the REIT sector, and through it, the real estate industry directly.”⁶ Those who grasp the reality of this opportunity and acquire real estate during this period stand to prosper. ⁶ Corner, Kevin. “REITs: Completing the Cycle.”

### BRIEF DESCRIPTION OF THE DRAWING

In the detailed description which follows, reference will be made to the drawing comprised of the following figures:

FIG. 1 is a chart which illustrates the various states of the real estate cycle;

FIG. 2 is a chart which illustrates how the idealized 18⅓-year real estate cycle ties in with the broader business cycle, as described by Wenzlich and Fisher; and

FIG. 3 is a chart illustrating the public non-traded REIT fundraising monthly trend ($ in million).

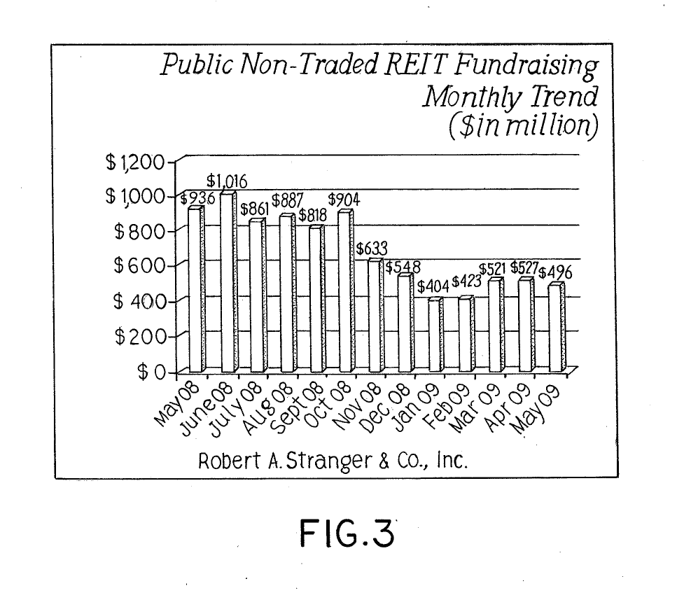

### DETAILED DESCRIPTION OF AN EMBODIMENT OF THE INVENTION

The aim of this Fund is to provide investors with an opportunity to take advantage of the current commercial real estate environment by offering them an affordable piece of ownership in the low-load, research based Real Estate of America Investment Fund. REAIF will capitalize on this opportunity by raising capital now and buying iconic, high value properties as opportunities become available, developing and managing them to their full potential, and then selling them when prices again approach their peak 7-12 years hence.

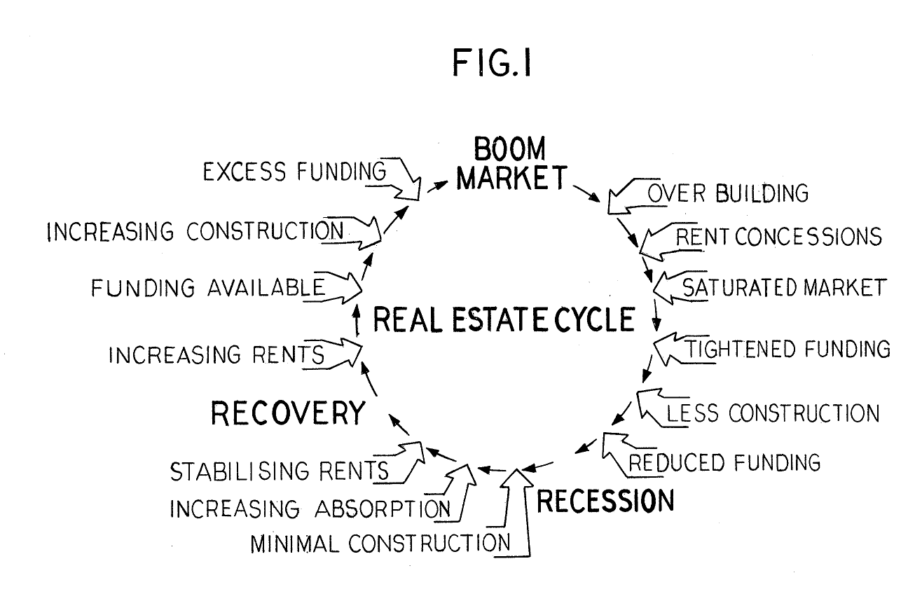

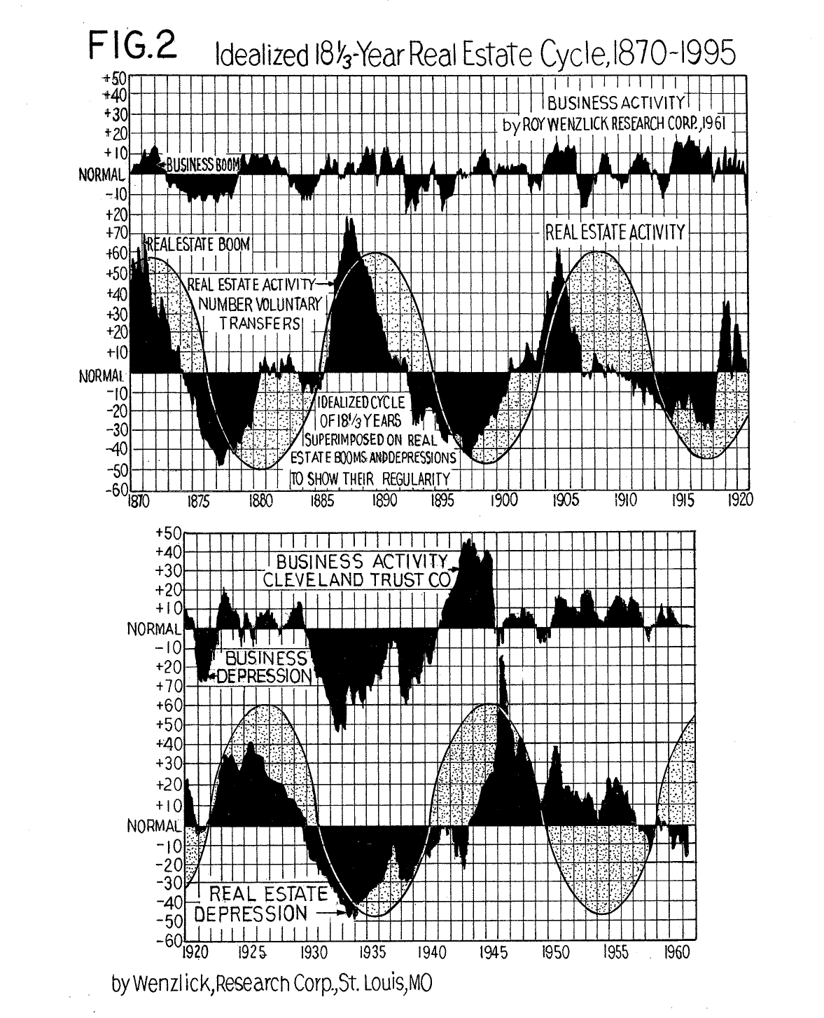

The graphics (FIGS. 1 and 2) illustrate the cyclical nature of real estate markets. The first chart illustrates the various stages of the real estate cycle in more detail. The second chart shows how the idealized 18⅓-year real estate cycle ties in with the broader business cycle, as described by Wenzlich and Fisher.

This cycle has the following periods:

| | |
|---|---|
| 1984-1987 | Liquidation of assets |
| 1991-1997 | Accumulation of assets |
| 2002-2004 | Liquidation of assets |
| 2009-2015 | Accumulation of assets |
| 2020-2024 | Liquidation of assets |

Finally, note that although we have identified what we believe to be “the real estate cycle,” in reality there are two cycles that drive real estate values.

Real estate, while a financial investment, is also a “commodity” of utilization. Within that context, real estate reflects the economy. When business is good, office space, industrial warehouses and distribution centers have high levels of demand. When consumers are healthy, retail space is in demand and so is housing. Thus, real estate cycles are closely correlated to credit cycles; but they are truly two separate cycles.

Good real estate markets are characterized by strong demand, low vacancies and high rent. Bad real estate markets have the opposite set of circumstances. Good credit markets usually mean that credit is easily available at market acceptable costs. In bad credit markets, debt is not available or is very expensive.

Thus, there are four possible combinations:

1. Bad credit market with a bad real estate market. This is usually a low velocity market without much buying. Prices have farther to fall so it is a time for buyers to be cautious and usually results in forced selling.

2. Bad credit with a good real estate market. This can't last long—either credit recovers or the good real estate market follows into a bad real estate market. If the bad credit market leads, then it's time to sell. If the bad credit market is moving toward a recovery or good credit market, then it's time to buy cautiously.

3. Good credit market with a bad real estate market. If a good credit market is leading the cycle, then the real estate market will recover and it's a buying opportunity. If the real estate market is leading, then it's a time to sell, not buy.

4. Good credit market with a good real estate market. It can't get any better than this—it's a market top and a good time to sell. Ironically, this is the time when most people buy. This is what we just experienced in 2005 to 2008 when the credit markets disguised a deteriorating real estate market in which prices were in reality too high.

As it pertains to our forecasted real estate cycle from 1993, we identified 20022004 as the top of the real estate investment cycle. In reality, the top was between 2006 and 2008. Fundamentals caused the market to last longer than it should have. Specifically, the period 2001-2007 of easy credit occurred primarily as a result of the tech bust of 2000 and the terrorist attack of September 11^{th}. The Federal Reserve, almost out of fear, kept interest rates artificially low for an extended period of time which in turn created too much easy credit. This drove real estate prices higher—too high based on real estate fundamentals creating the bubble from which the economy now suffers. The cycle was not sustainable. This bursting of the bubble and credit markets creates today's opportunity: the liquidation of bad debt and forced real estate asset sales.

Leverage, or the utilization of debt, enhances returns by creating a “multiple” on the invested equity by virtue of the benefits of borrowed money. The leveraged real estate investment model is well known and backed up by financial analysis. Thus, leverage enhances return on equity and as a result markets move based on the availability of debt. When debt is abundant, prices go up; when debt is scarce, prices go down.

This latest real estate cycle, however, has called attention to the downside of debt. Simply stated, too much debt places too much money in the hands of buyers, which in turn drives pricing upward, unrelated to the underlying real estate value but rather related to the costs and availability of debt. In contrast, when debt evaporates, prices decline as there are fewer available buyers. Instead of bidding prices upward, many are forced to liquidate their holdings. This scenario plays out every 18 or so years creating the boom/bust cycle of real estate, although each time it is triggered by a unique cataclysmic economic event. “As we have clearly seen, liquidity—the availability or lack thereof—plays a critical role in the actual sales price of a property. The values of all asset classes in 2003 to 2006 were greatly exaggerated due to an abundance of high loan-to-value, cheap debt. The opposite is true today. The lack of available debt is causing exaggerated decline in value.”⁷ These same distressed sales of real estate assets took place in the early 1990s, and this process repeats itself over and over in every economic cycle. ⁷ Procida, William (March 2009) “The Mysterious V(alue): Intrinsic vs. Perceived.”

The fund will operate under careful consideration and make decisions based upon in-depth financial due diligence complemented by expert research covering market conditions, demographics and economic forecasts.

Investment Principles

The best real estate.

At a good asset value.

Conservatively financed.

This premise of real estate investment increases the probability of a successful investment. It creates the opportunity for good things to happen.

Strategic Drivers

As income and net worth have been substantially reduced during this worldwide economic downturn, raising capital will probably be difficult. In order for the fund to gain traction and successfully persuade investors to purchase shares, a number of issues must be addressed.

Trust—the trustworthiness of the management team, board of directors and company must be conveyed to potential shareholders through partners, advisors, and other communication channels.

Transparency—the Fund must emphasize its commitment to transparency and diligent corporate governance through the prospectus, the website, all marketing materials, corporate communications, and customer service.

Fees—must be lower than the industry average, and must be structured so that investors feel they are receiving a better deal than they would with competing real estate investment opportunities.

Liquidity—there should be redemption periods at certain points throughout the Fund's lifetime to mitigate investor's desire for liquidity.

Education—given the fact that not all investors are knowledgeable about the nuances of real estate investing, education will be key to winning investor commitment.

These strategic drivers will help differentiate the fund from competing real estate trusts and funds.

Market Size and Current Conditions

There is approximately $3.46 trillion in commercial real estate loans outstanding, only $900 billion of which have been securitized (CMBS) in a manner similar to home mortgages. Moreover, because the bearish economic conditions affect almost every sector of the U.S. economy, “the IMF estimates that the cumulative loss rate on U.S. commercial real estate loans from 2007-2010 will come in at 9.8%.”⁸ As a result of distressed properties or distressed sellers, billions of dollars worth of real estate assets will become available at a considerable discount based on the listed purchase prices just a few years ago. ⁸ BCA Research (May 29, 2009) U.S. Investment Strategy Paper

Because many credit markets have shut down or drastically reduced their debt level offerings, many who would normally qualify under better market conditions will be turned away because of the tightened underwriting conditions. “At least two-thirds of the loans maturing between 2009 and 2018 ($410 billion) are unlikely to qualify for refinancing at maturity without significant equity infusions from borrowers . . . . We estimate that maturity default-related losses will be at least 4.6% for the 2005 vintage, 5.8% for the 2006 vintage and 12.5% for the 2007 vintage.”⁹ Thus, with sufficient capital, the fund will be strategically placed to take advantage of the impending defaults, delinquencies or inability of borrowers to refinance upon loan maturity. ⁹ Deutsche Bank Global Markets Research (Apr. 22, 2009) CMBS Research: Potential Refinancing Crisis in Commercial Real Estate, page 4.

Estimated percentage of loans that do not qualify for refinancing.

TABLE I
Loans Maturing 2009-2012
Refinancing Requirement: LTV <70 & DCSR >1.3

| | | | Loans Not | Loans Not | % Not | % Not |
|---|---|---|---|---|---|---|
| Property | | Balance | Qualifying | Qualifying | Qualifying | Qualifying |
| Type | # Loans | ($BB) | (#) | ($BB) | (Loan Count) | (Balance) |
| Hotel | 475 | 7.3 | 182 | 4.1 | 38.3 | 55.5 |
| Industrial | 1,189 | 5.8 | 330 | 2.2 | 27.8 | 37.9 |
| Multifamily | 3,793 | 24.4 | 2,220 | 18.9 | 58.5 | 77.3 |
| Office | 2,629 | 40.9 | 1,433 | 30.8 | 54.5 | 75.3 |
| Retail | 4,156 | 44.6 | 1,727 | 24.6 | 41.6 | 55.1 |
| Multi | 672 | 29.6 | 339 | 21.1 | 50.4 | 71.3 |
| Property | | | | | | |
| Other | 1,545 | 12.0 | 639 | 8.7 | 41.4 | 71.9 |
| Aggregate | 14,459 | 164.7 | 6,870 | 110.3 | 47.5 | 66.9 |

Source: Deutsche Bank

Estimated percentage of loans that do not qualify for refinancing. This figure provides the results from the same analysis as the previous case, except that only the L TV constraint is applied for qualifying. Here the percentage that does not qualify drops to 56%.

TABLE II
Refinancing Requirement: LTV <70

| | | | Loans Not | Loans Not | % Not | % Not |
|---|---|---|---|---|---|---|
| Property | | Balance | Qualifying | Qualifying | Qualifying | Qualifying |
| Type | # Loans | ($BB) | (#) | ($BB) | (Loan Count) | (Balance) |
| Hotel | 475 | 7.3 | 168 | 3.9 | 35.4 | 52.7 |
| Industrial | 1,189 | 5.8 | 286 | 2.0 | 24.1 | 34.4 |
| Multifamily | 3,793 | 24.4 | 1,958 | 17.3 | 51.6 | 70.8 |
| Office | 2,629 | 40.9 | 1,357 | 27.1 | 51.6 | 66.3 |
| Retail | 4,156 | 44.6 | 1,655 | 22.4 | 39.8 | 50.3 |
| Multi | 672 | 29.6 | 306 | 15.0 | 45.5 | 50.5 |
| Property | | | | | | |
| Other | 1,545 | 12.0 | 573 | 4.0 | 37.1 | 33.0 |
| Aggregate | 14,459 | 164.7 | 6,303 | 91.6 | 43.6 | 55.6 |

Source: Deutsche Bank

According to NAREIT, the National Association of Real Estate Investment Trusts, there are 41 publicly registered non-traded or private non-traded REITs.¹⁰ Major industry players include Inland Real Estate Corp., Wells Capital, Cole Real Estate Investments, KBS Capital Advisors, Behringer Harvard, Apple Hospitality, Grubb & Ellis REIT Advisor and CBRE Advisors. (A full list of these competing investment vehicles can be seen in the supplementary materials.) ¹⁰http://www.reit.com/AllAboutREITs/NonExchangeTradedPrivateRealEstateCompanies/tabid/395/Default.aspx

NAREIT reported that the total market capitalization of REITs exceeded $438 billion in 2006. Since this peak, the number of REITs dropped from 183 in 2006 to 136 in 2008, with a 2008 market capitalization of just over $191 billion. Despite what would appear to be a movement away from REIT securities, there have been a number of new registrations and offerings for non-traded REIT vehicles in 2009. Moreover, the ten largest non-traded REITs have already raised $2.105 billion through May of this year, which represents 81.2% of the overall non-traded REIT market.¹¹ The concentration of fundraising among the top ten funds has steadily declined since 2005 when the largest sponsors accounted for 93.5% of the fundraising market share. This bodes well for REAIF as it shows newer or smaller sponsors have entered the market and been able to gain access to capital. ¹¹ Allaire, K. (2009) The Stanger Report: Non-Traded REIT Industry Mid-Year Review & Outlook, Slide 12

In addition, the fund will have built-in advantages versus existing trusts or funds that are hampered with legacy assets on their balance sheets. A good percentage of assets were purchased with too much leverage and these non-traded REITs have been forced to sell at distressed values when unable to re-finance their debt. As a result, many funds have slashed dividends. According to Robert A. Stanger & Co., at least eight funds over the past twelve months have cut dividends, at an average of 27%. The fund will not be burdened by ill-considered acquisitions that hurt profitability and prevent it from being able to pay its 6% per annum dividend.

Fee structure will be another marketable advantage for the Fund. While there are funds that take less than the proposed 1.5-2% management fee on funds raised, often the end of fund proceeds split might be 50/50 or 40/60.¹² The fund intends to keep yearly management fees low, minimize transactions costs and split investment proceeds upon closure of the Fund at 20/80, where 80% of proceeds are awarded to the shareholders. Any returns in excess of the stated goal of the Fund will be distributed as a waterfall. 16 REAIF will emphasize the Fund's dedication to promote the investor's interest versus industry standards, where REITs look to charge fees whenever and wherever possible. ¹² Real Estate Alert (2009). Fee Scorecard for Active Real Estate Funds. For a full list, please see the document in the supplementary materials.

The fund distinguishes itself from other funds in a number of ways.

The Fund is timed to take advantage of the commercial real estate cycle.

The Fund is not burdened by legacy assets on its balance sheet.

A low cost of capital puts more of investors' money to work.

An extremely high degree of transparency combined with superior ability to execute transactions and manage portfolio assets.

A green, sustainable focus.

The extremely low management fees align investors and management to share in the Fund's success.

A public, non-traded REIT reduces correlations with stock market volatility and frees management to focus on delivering value.

Three types of commercial real estate investment comprise the fund: iconic properties, opportunistic purchases and property development.

Iconic assets are also known as trophy or Class A properties. However, there exists no specific definition or objective measure of an “iconic” property. Nevertheless, there are some identifiable characteristics that provide a property with a competitive advantage: it draws people to the property because the structure possesses brand name recognition; the property as it exists does not allow other land or real estate opportunities to create a competitive or parallel product in the nearby area; the asset has timeless demand; the asset and space within the property provides marketability because someone else cannot easily re-produce that asset; and lastly, the asset has market currency in today's environment and into the future because it cannot be easily replicated.

Iconic properties possess one fundamental characteristic that supersede all other real estate assets: scarcity. Scarcity can take one of several forms: location, property quality or market dominance. Scarcity also provides barriers to entry by virtue of geographical limitations, zoning constraints and reproduction costs in that it becomes inherently difficult to produce a similar iconic property in the general vicinity of the asset REAIF will seek to acquire.

Opportunistic asset purchases should be abundantly available at the Fund's inception given the market dynamic afflicting the real estate industry now and the prediction that it will continue for several years. These real estate assets have suffered severely during the current downturn, evidenced by low occupancy and perhaps a need for remodeling. Demand for these opportunistic assets will be far less than iconic assets and therefore, lighter leverage will not adversely affect the Fund's ability to win a bid on an asset. The strategic initiative behind such purchases will be to implement green designs and retrofit properties where cost-benefit analyses justify, lower rents, increase occupancy and sell as the real estate market heads toward its next peak.

The fund will primarily focus on the above two opportunities but will retain the right to invest capital in the development and redevelopment of commercial real estate projects, including a variety of real estate classes that will become multi-use facilities. For example, an investment may mean the purchase of an office building or manufacturing warehouse that is redesigned into condos/apartments with retail and office space on the lower floors.

The fund will perform careful due diligence and market research for any property that appeals to the Fund. A number of criteria and associated algorithm will assist in the valuation of assets and their cash flows including:

Current and projected cash flow

Geographic location and property type

Condition and use of the assets

Historical performance

Potential for capital appreciation

Potential for economic growth in the area where the assets are located

Presence of existing and potential competition

Prospects for liquidity through sale, financing or refinancing of the assets

Tax considerations¹³ ¹³ Inland Realty http://www.inland-american.com/subpage.asp?menu=acquisitions&file=portfolio

As mentioned earlier, leverage should be used conservatively. Different leverage ratio ceilings depending upon the type of real estate will be used. For example, the Fund would use a maximum leverage ratio of 60% for retail, 70% for multi-family, 30% for office and 0% for land. Ideally, the Fund would like to keep leverage at around 40% on average across all classes.

Green Street Advisors calculated that for the 29 most prominent REITs over the past 15 years, “the research firm found, everyone percentage-point increase in leverage has been accompanied by a 0.4 percentage point decrease in annual returns, which include stock price gains and dividends.”¹⁴ The fund will seek to minimize leverage wherever possible to better manage exposure to credit market fluctuations, but also to realize the best returns possible for the Fund's shareholders. ¹⁴ Troianovski and Hudson (May 2009) “At REITs, a Debate on Debt.”

The fund will focus on major metropolitan areas, urban centers, and regions situated for job market growth. According to the Bureau of Labor Statistics, San Francisco, San Jose, Seattle, and Austin are leading cities by household income distribution.¹⁵ Moreover, Grubb and Ellis predicts that “metropolitan areas specializing in technology, biotech and renewable energy and those able to attract young, educated workers [should] prosper in the long run—areas like Seattle, Portland, San Francisco, Silicon Valley, San Diego, Denver, Austin, Raleigh-Durham, the greater DC area and Boston.”¹⁶ The fund will take advantage of the recovery in the job market and overall economy into the longer term. ¹⁵ http://www.bls.gov/bls/wages.htm¹⁶ Bach, Robert. “Good News Friday: Where the Jobs Are, Part Two” (May 22, 2009).

Experts hypothesize that job growth in the United States will be centered in regions and cities that are considered higher education hubs. “The University of Chicago economist and Nobel laureate Robert Lucas declared that the spillovers in knowledge that result from talent-clustering are the main cause of economic growth. Well-educated professionals and creative workers who live together in dense ecosystems, interacting directly, generate ideas and turn them into products and services faster than talented people in other places can . . . the economy is shifting away from manufacturing and toward idea-driven creative industries—and that, too, favors America's talent-rich, fast metabolizing places.”¹⁷ ¹⁷ Florida, Richard. (March 2009). “How the Crash will Re-Shape America.: The Atlantic

Real estate should be priced at a capitalization rate of 8%-10% for improved, performing commercial real estate. During the boom period earlier this decade, property buyers were accepting capitalization rates as low as 4%-5% because everyone had access to debt which in turn placed upward pressure on bid rates. Now many analysts forecast that capitalization rates should rise as there are fewer viable investors given the tightened lending standards now enforced by debt providers.

As investment risk has increased, actual cap rates have risen nationally over the last five quarters and continue to rise across most markets and property types . . . with few financing options and receding tenant demand, investors and real estate companies have shifted into a mode of managing and protecting their existing assets, with landlords cutting costs and rushing to sign or renew tenants—in many cases offering sweet incentives and concessions such as free rent. The result is lower revenue and higher overall cap rates reported for the few investment sales that are being completed.¹⁸ ¹⁸ Drummer, Randyl. (Mar. 18, 2009). “Survival Mode: Rising Cap Rates Add to Real Estate Inventors' Worries.” http://www.costar.com/News/Article.aspx?id=805689186917C1830E65776FC4A47B2B

Real estate performance, as measured by cash flow, reflects the financial health of its tenancy, which in turn is a mirror of the underlying economy. As the economy has tightened, employers have reduced staff and cut back on office space. This market seizure provides major opportunities in real estate. High leverage on overvalued real estate, regardless of the interest rate, will eventually meet its own failure, which is exactly what is underway now. This environment will result in forced liquidations of real estate, due to distressed assets or distressed owners. This will subsequently lead to lower asset prices, higher capitalization rates and the opportunity to acquire real estate at fair and appropriate prices with a correlation to true and underlying value.

The Internet

The fund website will be the focal point of all Internet marketing efforts. The website must be well-organized and content-rich, scalable (able to handle large numbers of visitors and transactions), and robust (free of static or execution errors, dynamic page loading, and with exceptionally low downtime). The website will also:

Provide a wide variety of static and dynamic educational information on the REAIF investment philosophy.

Provide investors with detailed reports on real estate markets in its portfolio.

Handle other aspects of investor relations (such as customer service contact information, Frequently Asked Questions, etc.).

Qualify potential investors.

Handle all share purchases.

Provide a forum for REAIF investors to communicate with each other.

Search Engine Optimization (SEO) and Pay Per Click (PPC) advertising will form an integral part of the website marketing effort. The REAIF website will be optimized for a large number of targeted keywords of interest to potential investors. A variety of PPC campaigns and ads will be used to attract potential investors to the website. These will likely include banner and text ads on the Google, MSN, Yahoo and AOL networks.

Blogs will be an important component of the marketing plan. The key here will be to build trust and awareness through ongoing postings and discussions. In order for these blogs to be useful, they must be credible, educational, and timely. In particular, the blogs should be updated at least two or three times a month.

Opt-in email campaigns will be used to build awareness and drive traffic to the website. REAIF will only use high quality opt-in email providers who guarantee no blacklisting and follow all anti-spam legislation to the letter. Recipient lists will be carefully targeted with differentiated messages appropriate to each market segment. Prospects and investors alike will also be encouraged to subscribe to a high quality email newsletter managed by the REAIF marketing communications group.

Print

Although the Internet is the heart and soul of the fund marketing plan, print advertising will also play a significant role. Many people still rely on printed media for much of their news. This is especially true of people over the age of 30.

Funding

The fund seeks an initial investment raise of $10 million to fund start-up costs such as website development, consulting engagements, legal fees to draft the offering memorandum, complete SEC certification/registration, and to commence the multipronged marketing strategy to reach the various investor market segments. The offering memorandum, website, strategic alliance agreements, and management team build-out are expected to take 5-6 months.

Once these initial tasks are completed, the fund will offer the public shares priced at $10 per share with a minimum subscription of 300 shares. The fund seeks to raise at least $1 billion in capital to devote to real estate acquisitions. The Fund is expected to close in no longer than 24 months, which corresponds to an average raise of ˜$417,000 per month, or around $15,000 per day. Once the Fund reaches a critical mass of $500 million, the fund will begin acquiring properties. Those investors who purchase shares before the $500 million threshold is reached will have their funds placed in a secure escrow account where they will earn minimal interest.

Most non-traded REITs today have a high fee structure so that only 80%-85% goes into real estate acquisitions. Shareholder returns can only be so much under such an arrangement. REAIF is designed to keep transaction costs as low as possible for shareholders, so that as much as 90%-95% goes into the Fund. In addition, by providing entrance into the Fund at the cost of just $3,000, the fund will allow regular investors the opportunity to take advantage of ownership in real estate assets that were previously available only to institutional investors and wealthy families/individuals.

Shareholders will receive preferred dividends at a rate of approximately 6% per annum.

At the end of the Fund's lifetime shareholders and management will split profits according to the traditional 80/20 profit sharing arrangement with a waterfall structure as returns rise. Investors who participate in the early ($10 million) round will receive preferred treatment above and beyond that of standard shareholders. After the Fund closes to new investors, the Fund will have a 7-12 year life, unless extended by vote or proxy of the shareholders.

Since the investment methodology is applicable to a trust model as well as a fund model, the invention is not to be limited by the model chosen, but is limited only by claims set forth and equivalents.

What is claimed is:

1. A method for investing in real estate comprising the following steps:
(a) establishing a real estate investment trust or fund by selling unit shares in small aliquots in the range of less than about $3,000.00 to capitalize said trust;
(b) establishing the periodicity of cyclical credit availability for real estate property in a geographical region to identify a range of time of maximum credit requirement within the cyclical period;
(c) apportioning a maximum investment in select properties by said trust or fund during said range of time;
(d) maintaining and managing the select properties for a second period of time less than the entire cyclical period, said second period of time extending for a term until a range of minimum credit requirements are observed in the real estate market; and
(e) terminating the maintaining and management by selling substantially all of the previously acquired real property following said second period of time and prior to the end of the cyclical period;
said steps of selling unit shares, primarily conducted through the Internet by securitized governmental approved entities, said apportioning of investment step conducted primarily in accord with at least one algorithm depending upon standardized credit reports in the cyclical period.
